(19) United States
(12) Patent Application Publication
(10) Pub. No.: US 2010/0322890 A1
(43) Pub. Date: Dec. 23, 2010

(54) Pathogen eradication composition

(76) Inventor: John Lee Edwards, Sarasota, FL (US)

Correspondence Address: John L. Edwards, 6222 Tower Lane, B-4, Sarasota, FL, 34240, US

(21) Appl. No.: 12/080,736

(22) Filed: Apr. 5, 2008

Related U.S. Application Data
(60) Provisional application No. 60/922,011, filed on Apr. 6, 2007.

(51) Int. Cl. A01N 33/12; A01P 1/00

(52) U.S. Cl. 424/78.08

(57) ABSTRACT

Disinfecting compositions comprising the synergistic combinations of polymerized quaternary ammonium compounds and super spreading agents, integrated with substrates that need protection from pathogens. The aqueous based polymers require minimal use of organic solvents in their preparation, contain no volatile organic compounds, and are mild to the user. The composition may be integrated, by coating or by pre-form blending, with either a hydrophilic or lipophilic substrate needing microbial protection properties. Once integrated, the composition properties of electrostatic attraction and microbial destruction are non-consuming and non-leaching, giving the substrate sustained efficacy against viruses, fungi, bacteria, and spores that contact it.

### CROSS-REFERENCE TO RELATED APPLICATIONS

This application claims priority from provisional filing 60/922,011 “Pathogen Eradication Composition” filed Apr. 6, 2007.

### BACKGROUND OF THE INVENTION

The present invention relates to a method for preventing infection and disease caused by an infective or disease agent. More specifically, the invention relates to a method for giving inanimate objects long lasting anti-microbial properties.

This invention relates broadly to removal through eradication of microorganism contaminants of many types. There are two fundamental approaches to eradication of microorganisms—oxidation and chemical. Oxidants kill microorganisms as a consequence of removing electrons from their organic molecular building blocks, causing their cascade breakdown into smaller and smaller protein fragments and eventual conversion of all cellular matter into natural elements. Chemical compounds kill microorganisms as a consequence of disrupting their natural regulatory or nutritional biochemicals, or disrupting their plasma membrane causing loss of control over permeability and consequent death of the micro-entity. This invention relates to a method that utilizes a chemical polymer composition to bind, rupture, and destroy the plasma membrane.

As used herein, an “antimicrobial agent” is an agent that destroys or inhibits the growth of microorganisms, particularly pathogenic microorganisms, and their spores, mycotoxins, and related allergenic cellular debris. The principal classes of microorganisms are bacteria, fungi including mold and mildew, yeasts, and algae, plus viruses and to a lesser extent prions. (Prions are rogue agent proteins containing no genetic material, e.g. mad cow disease.) Microorganisms can be found in the air, the water, in and on the human body and bodies of animals, soil, wastes, and on all surfaces. The microorganisms are deposited from the air, food and drink spills, dust, and dirt and tracked in soil, and from human and animal excreta such as sweat, urine, and feces. Organisms grow and multiply when there is available a nutrient source of food such as organic or inorganic material contained in such wastes, dirt, dust, and living tissue. For growth and multiplication, most microorganisms also require warm temperatures, and moisture. When these conditions exist, microorganisms multiply, grow and flourish. Microbial growth, however, leads to many problems, such as unpleasant odors ranging from stale to musty and mildew-like, to putrid and foul smelling, resembling ammonia. The growths also produce unsightly stains, discoloration, and deterioration of many surfaces and materials in which they come into contact. A more serious disadvantage of microbial growth is the proliferation of pathogenic microorganisms, their metabolic products and their somatic and reproductive cell parts, which contribute to the spread of disease, infection, and health disorders.

Viruses are associated with a large number of infections and diseases in avians and mammals, such as man. They are not complete microorganisms, but parasites that use, and often destroy, a host to replicate and multiply. Although modern medical science has developed some treatment techniques that are effective to prevent a particular disease, e.g., the polio vaccine, the art generally lacks a method to prevent a large number of different virus infections that are being transmitted in breathable air or on objects touched by carrying plants or animals, including humans. Past treatments of various diseases caused by viruses have been largely ineffective. Accordingly, there is a strong need for a method that can effectively treat or prevent infections and diseases caused by viruses in a mammal or avian.

There has been a great deal of attention in recent years given to the hazards of bacterial contamination from potential everyday exposure. Noteworthy examples of such concerns include the fatal consequences of food poisoning due to certain strains of Escherichia coli being found within undercooked beef in fast food restaurants; Salmonella contamination causing sicknesses from undercooked and unwashed poultry food products; and illnesses and skin infections attributed to Staphylococcus aureus, Klebsiella pneumoniae, yeast, and other unicellular organisms. With such an increased consumer interest in this area, manufacturers have begun introducing antimicrobial agents within various everyday products and articles. For instance, certain brands of polypropylene cutting boards, liquid soaps, etc., all contain antimicrobial compounds.

Because hospital-acquired bacterial infections are the leading cause of hospital or long-term care infections, numerous attempts have been made to create antimicrobial surfaces in hospital and medical facilities. Most treatments rely on the use of antimicrobial washes to achieve a coated surface that is resistant to bacterial growth. Unfortunately, this indiscriminate use of antimicrobial agents results in the build up of increased resistance of bacteria and certain other microorganisms to the widely used antimicrobial agents. This presents a significant problem for those being treated in health care facilities, and particularly for immune-compromised patients.

Mold is a type of ubiquitous microscopic fungus, feeding on plant or animal matter in the presence of excess moisture. It reproduces by spores, instead of seeds, that float in the air like pollen and are a common component of house dust. Spores are a common trigger of allergies. Excess mold causes sickness and other indoor air quality problems. Toxic black mold (Stachybotrys chartarum) causes neurological disease and death.

Pathogens have the form of fungi, bacteria, viruses, their spores, and contaminant particles such as mycotoxin and prions. The structures differ somewhat but prokaryotes (bacteria and algae) can serve as a basic reference model. The outer surface layer is a capsule which is constructed from materials secreted by the cell, essentially an envelope of gel surrounding the cell, usually polysaccharide but sometimes polypeptide in nature.¹ If this glycocalyx material is loose in structure and “gooey” it is defined as a slime. Capsules are not essential to bacterial viability under favorable conditions, and only gram positive bacteria have capsules. Yet many pathogenic bacteria can no longer cause an active infection when deprived of their capsule, apparently because of the protection it gives the bacteria against host defenses. ¹ MerckSource, Health Library, Home Edition. http://www.mercksource.com/pp/us/cns/cns_health_library_frame.jspzQzpgzEz/pp/us/cns/cns_hl_dorlands.jspzQzp gzEzzSzppdocszSzuszSzcommonzSzdorlandszSzdorlandzSzdmd_c_{—}07zPzhtm

Within the capsule is the cell wall, a unique structure which surrounds the cell membrane. Although not present in every bacterial species, it is very important as a cellular component, and structurally is necessary for: (a) maintaining the cell's characteristic shape—the rigid wall compensates for the flexibility of the cellular membrane and keeps the cell from assuming a spherical shape, (b) countering the effects of osmotic pressure—the strength of the wall is responsible for keeping the cell from bursting when the intracellular osmolarity is much greater than the extracellular teichoic osmolarity, (c) providing attachment sites for bacteriophages—teichoic acids attached to the outer surface of the wall which are like landing pads for viruses that infect bacteria, and (d) providing a rigid platform for surface appendages—flagella, fimbriae, and pili that emanate from the wall and extend beyond it.

The cell wall is not a regulatory structure like the cell membrane. It is porous, and is not selectively permeable. It will let anything pass that can fit through its gaps. Cell walls are composed of materials that are found nowhere else in nature, many polymer layers of peptidoglycan connected by amino acid bridges. Bacteria that will accept a color stain for better microscopic observation (gram-positive) have a thicker wall of 0.015-0.08 microns, comprising 10-25% of the cell's dry weight. (Gram-negative bacteria have a thinner (about 0.01 micron) cell wall of a more complicated structure.)

Inside the cell wall is the cell membrane, or cytoplasmic membrane, which is attached to the cell wall at relatively few points. It contains all the cellular matter, or cytoplasm of the bacteria. It is the essential barrier through which nutrients, waste products and secretions must pass, and the cell maintains considerable selectivity over it. A bacteria may survive without capsule and cell wall, but it cannot survive without its membrane.

Inside of the cell membrane there is a high solute concentration and a great pressure on the membrane (75 lb/in2). Outside of the membrane there is a low solute concentrate. A fundamental law of physics is that water will tend to flow into a cell to equilibrate the amount of water inside and outside of the cell. Membranes prevent most other molecules from crossing them, but water can. Without something supporting the membrane the cell would swell and burst. A cell wall protects bacteria from osmotic lysis.

Most suspended contaminants have a natural electrostatic charge present on them. Large macromolecules generally have a natural positive charge. For example, tobacco smoke particles, odors and many allergens tend to be positively charged, which helps keep these large particles suspended in air. Small microorganism particles typically have a negative charge on them. Most bacteria and their fragments carry a net negative surface charge due to their cell wall chemistry, and there are few rare instances of positively-charged bacteria (such as S. maltophilia).² Gram negative bacterial cell surfaces possess net negative charge by virtue of ionized phosphoryl and carboxylate substituents on outer cell envelope macromolecules.³ The outer layer of lipopolysaccharides and protein forms a highly charged surface.⁴ Variations in the structure and chemical composition affect the bacterial surface charge.⁵ Gram-negative bacterial endotoxins (pyrogens) are also negatively charged as are viruses and most colloids.⁶ Most protozoan⁷ are negatively charged as well. The ability to place or alter an electrostatic charge on a suspended particle is directly related to its total surface area and its total mass. It is more difficult to alter or increase the natural electrostatic charge on a small contaminant particle than on a large particle. ² Jucker, B. A., Harms, H & Zehnder, A. B. (1996). Adhesion of the positively charged bacterium Stenotrophomonas (Xanthomonas) maltophilia 70401 to glass and Teflon. Journal of Bacteriology 178, 5472-9³ W. W. Wilson, M. M. Wade, S. C. Holman, F. R. Champlin, “Status of methods for assessing bacterial cell surface charge properties based on zeta potential measurements,” J. Microbiol. Methods 43 (January 2001):153-164.⁴ A. A. Peterson, R. E. W. Hancock, E. J. McGroarty, “Binding of polycationic antibiotics and polyamines to lipopolysaccharides of Pseudomonas aeruginosa,” J. Bacteriology 164 (December 1985):1256-1261.⁵ S. A. Makin, T. J. Beveridge, “The influence of A-band and B-band lipopolysaccharide on the surface characteristics and adhesion of Pseudomonas aeruginosa to surfaces,” Microbiology 142 (February 1996):299-307⁶ Argonide Corp Nanocerm under Table 3 Filtration Mechanisms.⁷ M. Espinosa-Cantellano, A. Gonzales-Robles, B. Chavez, G. Castanon, C. Arguello, A. Lazaro-Haller, A. Martinez-Palomo, “Entamoeba dispar: ultrastructure, surface properties and cytopathic effect,” J. Eukaryot. Microbiol. 45 (May-June 1998):265-272.

Quaternary ammonium compounds, chitin, inorganic compounds and natural extracts are commonly used as anti-microbial agents. Quaternary ammonium compounds are widely used because they have no strong smells, have low toxicity, are chemically stable, and effectively destroy microorganisms without causing irritation to the human body.

Quaternary ammonium compounds are surfactants, salts of cations. Quaternary ammonium cations are polyatomic ions of the structure NR₄⁺ where R's are alkyl, aryl, or alkylaryl groups of from 6 to 26 carbon atoms, which assemble in a quaternary structure. They are permanently positively charged ionic compounds (“Cations”), independent of solution pH with a molecular weight of at least 165 daltons. When these positively charged compounds are combined with a negatively charged ion (“Anion”), the resulting compound is neutral, without a net charge, and called a “salt”.

The R groups in a quaternary ammonium compound may be the same or different alkyl groups, and any of the R groups may be connected. The alkyl groups may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the abovementioned alkyl substituents are hydrocarbons, usually containing no more than 12 carbon atoms. The R groups may be straight-chained or may be branched, but are preferably straight-chained, and may include one or more amide, ether or ester linkages. The counterion may be any salt-forming anion which permits water solubility of the quaternary ammonium complex.

Exemplary quaternary ammonium salts within the above description include the alkyl ammonium halides, formed from one of the halogen ions fluoride, chloride, bromide, iodide, or astatide. Preferred quaternary ammonium compounds which act as germicides and which are be found useful in the practice of the present invention include those where R₂ and R₃ are the same or different C₈-C₁₂ alkyl; or R₂ is C₁₂₋₁₆ alkyl, C₈₋₁₈ alkylethoxy, C₈₋₁₈ alkylphenolethoxy, R₃ is benzyl, and the halide is chloride. The R₂ and R₃ alkyl groups may be straight-chained or branched, but are preferably substantially linear. Broader activity has been shown against bacterial strains by the benzylated disulfides.⁸ ⁸ Rnaucci, R, Ferruti P., Neri M G, Alkylation products of linear aliphatic poly(aminodisulphides), J Biomater Sci Polym Ed. 1991; 2(4): 255-61.

Most mono alkyl quaternary ammonium compounds in the C₁₀-C₁₄ range are powerful broad spectrum biocides and, as such, they form the basis of household and industrial disinfectant and sanitizer formulations.⁹ The greatest bactericidal activity for benzalkonium chloride is attributed to the C₁₂-C₁₄ alkyl derivatives.¹⁰ In a research effort using different quaternary ammonium groups attached to insoluble polystyrene, the antibacterial efficiency increased as the substitute alkyl length increased.¹¹ In another, phytoxicity of a homologous series of sulphobetaine surfactants increased with increasing alkyl chain length from 8 to 14 carbon atoms, but leveled off and declined with the 18 carbon derivative.¹² ⁹ Cationic Surfactants, Orica Limited, ACN 004 145 868, 1992.¹⁰ Wikipedia, benzalkonium chloride, http://www.answers.com/topic/benzalkonium-chloride.¹¹ Shan Jiang, Li Wang, Haojie Yu, Ying Chen, Preparation of crosslinked polystyrenes with quaternary ammonium and their antibacterial behavior. Reactive and Functional Polymers, Volume 62, Issue 2, February 2005, pp 209-213.¹² JSTOR, New Phytologist, Vol. 96, No. 2, (February, 1984), pp. 197-205.

The quaternary ammonium compounds were found to exhibit anti-microbial activity in 1916 and were described by Domagk et al. in 1935. The anti-microbial mechanism is attachment of the quaternary ammonium compound to a microorganism by positive charges of the cationic group and subsequent reduction in enzyme activities of the membrane proteins. After changing the membrane protein activities, the cell walls and the cell membranes of microorganisms are destroyed, causing the microorganisms to die. Therefore, quaternary ammonium compounds have excellent anti-microbial activity against Gram-positive bacteria, such as Staphylococcus aureus, as well as anti-Gram negative bacteria, such as Escherichia coli. Furthermore, quaternary ammonium compounds are effective in repressing the proliferation of fungi and lipophilic viruses, such as herpes simplex, influenza and adeno virus.

Particularly useful quaternary germicides include compositions which include a single quaternary compound. The quaternary ammonium compound lauryl dimethyl benzyl ammonium chloride is the most common domestic and industrial biocide.¹³ It contains 100% C₁₂ in the primary R₁ radical group. ¹³ Cationic Surfactants, Orica.

More particularly, mixtures of two or more different quaternary compounds, including a blend of alkyl dimethyl benzyl ammonium chlorides are exemplary antimicrobials. Phillips in U.S. Pat. No. 6,462,079, entitled “Pharmaceutical composition and method of using the same”, teaches a pharmaceutical composition of two quaternary ammonium compounds together with an organometallic compound to systemically treat living mammal or avian for viral, bacterial, fungal infections and diseases. However, the composition is not intended for application to inanimate objects needing anti-microbial protection, does not teach the use or method of polymerized quaternary ammonium compounds, nor does it use super spreading agents for its application.

Quaternary ammonium compounds include those such as 3-(trimethoxysilyl) propyl dimethyl octadecyl ammonium chloride in U.S. Pat. No. 5,145,596S issued to Dow Corning and claimed compounds in U.S. Pat. No. 5,399,737 issued to Alcon Laboratories and in U.S. Pat. No. 6,613,755 issued to Coating Systems. But the compounds described above are small molecules like monomers, dimers or oligomers. Such compounds are suitable additives to solutions for environmental antiseptics. But with small molecular sizes, if they are coated on the surface of fabrics and goods, the anti-microbial activities of the goods will be totally lost after washing several times.

Although quaternary ammonium compounds have been known in the art, the art has failed to provide an effective treatment for a wide variety of infections and diseases associated with a variety of viruses, bacteria, fungi, and other disease causing agents. The present invention is addressed to this need.

This invention relates to a novel antimicrobial polymer composition and to a method of creating a solvent-free formulation of such polymeric antimicrobial material, preferably in the form of a dry powder or in solution in a solvent in order to impart antimicrobial activity onto or into another material. The composition of antimicrobial polymers, and their super-spreading, has superior antimicrobial properties compared to the similar monomers.

It is known that certain low molecular weight quaternary ammonium groups can be incorporated into polymeric substrates (without chemical bonding) in order to provide certain degrees of antimicrobial activity.

Ionene polymers or polymeric quaternary ammonium compounds (polyquats), i.e., cationic polymers containing quaternary nitrogens in the polymer backbone, belong to a well-known class of biologically-active compounds. See, e.g., A. Rembaum, Biological Activity of Ionene Polymers, Applied Polymer Symposium No. 22, 299-317 (1973). Ionene polymers have a variety of uses in aqueous systems such as microbicides, bactericides, algicides, sanitizers, and disinfectants. U.S. Pat. Nos. 3,778,476, 3,874,870, 3,898,336, 3,931,319, 4,013,507, 4,027,020, 4,089,977, 4,111,679, 4,506,081, 4,581,058, 4,778,813, 4,970,211, 5,051,124, and 5,093,078 give various examples of these polymers, their preparation, and their uses. U.S. Pat. Nos. 3,778,476, 3,898,536, and 4,960,590, in particular, describe insoluble tri-halide containing ionene polymers. U.S. Pat. No. 4,013,507 describes ionene polymers which selectively inhibit the growth of malignant cells in vitro.

Hou et al., U.S. Pat. No. 4,791,063, teach polyionene-transformed modified polymer-polysaccharide separation matrices for use in removing contaminants of microorganism origin from biological liquids. This patent teaches that absorption of bacterial cells by ion-exchange resins is attributable to electrostatic attraction between quaternary ammonium groups on the resin surface and carboxyl groups on the bacteria cell surface.

Limited quaternary ammonium compounds have been polymerized or copolymerized for the personal care industry. These compounds are called Polyquaternium and categorized by the International Nomenclature for Cosmetic Ingredients association. There are 47 separate polymers, used primarily in conditioners, shampoo, mousse, hair spray, and hair dye where the proteinaceous hair keratin benefits from the antistatic and other properties of the quaternary ammonium compounds used. Anti-microbial properties are generally related to contact lens cleaning and disinfecting solutions, which is of low concentration compatible with ocular tissue and solutions preservatives.

Despite knowledge of the common usage of quaternary ammonium salt monomers for imparting antimicrobial properties to solid surfaces, a method was not known for protecting surfaces through the use of polymerized quaternary ammonium compounds incorporated throughout the entire substrate or bound to the surface of the substrate. Getman et al., in U.S. patent application Ser. No. 2006/0223962 A1, entitled “Method of creating solvent-free polymeric silicone-containing quaternary “Ammonium Antimicrobial Agent Having Superior Sustained Antimicrobial Properties,” discloses an anti-microbial polymer containing silicon-containing quaternary ammonium groups, but his patent deals exclusively with silicon-containing compounds, and does not contain other novel elements of this invention.

Further, some antimicrobial surface treatments use a coating treatment that provides a vehicle for entrapping the antimicrobial agent on the surface but permits subsequent diffusion of the antimicrobial agent into the biological environment. Many such treatments rely upon a leaching mechanism to deliver the antimicrobial agent into the environment. There has been a long-felt need to provide durable, reliable, long-lasting, non-leaching antimicrobial substrates that exhibit effective antimicrobial characteristics throughout the substrate. Unfortunately, to date, no such substrates have been available from the industry, according to the pertinent prior art. Moreover, the antimicrobial agents described above are typically supplied in methanol. Methanol is toxic and explosive. There has long been a desire to provide the antimicrobial in a methanol-free form. The present invention satisfies these long-felt needs.

Thus, a method has not been devised to impart to a substrate non-leaching, biocompatible, chemically bonded antimicrobial properties throughout the entire substrate. Only the very surface has previously been made antimicrobial with a non-leaching antimicrobial agent through the formation of an interpenetrating network at the interface of the substrate surface and the antimicrobial agent, for only as deep into the surface as the antimicrobial agent could be adsorbed into the substrate. The present invention of chemically bonding or physically mixing a polymerized quaternary ammonium salt and a polymeric substrate, preferably in the form of a bulk resin substrate so made and methods of using such bulk resin accomplishes this goal. Thus, antimicrobial properties imparted to a material resulting from the present invention and its use are “sustained” when such material has long-lasting, non-leaching, antimicrobial properties not only on the surface, but also throughout the material, substrate, formed plastic product, device or other product made containing the antimicrobial agent of the present invention, if and when it is worked, molded, machined, abraded or otherwise formed into any desired product. As a result, whatever portion of the product made according to the present invention becomes the surface of such product after working, molding, machining, abrading or other forming or manufacturing process, the surface with which humans and animals have contact will be an antimicrobial surface. Such materials containing the antimicrobial polymer made using the present invention are not toxic to humans or animals.

Until now, antimicrobial polymers of polymerized quaternary ammonium salt monomers have not been incorporated into medical polymers, thin layer films or laminates in hospitals or on medical devices and supplies to impart antimicrobial properties to such devices and supplies. The present invention accomplishes this in such a manner that does not compromise their biocompatibility.

Among other things, the present invention relates to a method for creating a solvent-free polymeric antimicrobial agent for manufacture of medical devices and supplies that is biocompatible and antimicrobial throughout the entire composition of the device or supply.

The present invention also relates to a method for creating a solvent-free polymeric antimicrobial agent for manufacture of medical devices and supplies that is biocompatible and antimicrobial on the surface of the device or supply. The present invention also relates to a method for creating a solvent-free polymeric antimicrobial agent for manufacture of fabrics for clothing, outerwear, underwear, carpets, draperies, furniture and other articles containing fabric, for creating an antimicrobial agent for liquid solutions, for creating an antimicrobial agent for manufacture of a filter medium such as activated carbon, fiberglass, sand, fabrics and HEPA filtering materials, for building materials, including paint thin films; and consumer products, for creating a polymeric thin layer film or laminate having antimicrobial properties that can be applied to various medical and food supply surfaces.

### BRIEF SUMMARY OF THE INVENTION

A composition is provided for imparting long lasting pathogenic destruction properties to a broad array of applications susceptible to transmitting infectious disease. The composition comprises a first polymerized quaternary ammonium compound, a second polymerized quaternary ammonium compound and a super spreading agent in a combination suitable for systemically incorporating into applications needing anti-microbial properties.

Other aspects of the present invention also relate to methods of making and using such an antimicrobial polymer.

In addition, embodiments of the present invention include methods to produce a novel composition of a solvent-free polymeric form of quaternary ammonium antimicrobial agents. The resulting solid polymers provide enormous benefit in allowing the antimicrobial to be blended with as example; bulk resins, coatings, and laminates during their processing. The antimicrobial agent is incorporated throughout the treated material giving a non-leaching permanence, namely, sustained antimicrobial properties.

These and other objects will be made manifest when considering the following detailed specification.

### BRIEF DESCRIPTION OF THE SEVERAL VIEWS OF THE DRAWINGS

Not Applicable

### DETAILED DESCRIPTION OF THE INVENTION

As used herein, when a preferred range such as 5-25 is given, this means preferably at least 5 and, separately and independently, preferably not more than 25. Parts are parts by weight and percentages are weight percent unless otherwise indicated or apparent.

The composition comprises a quaternary ammonium compound (A) (sometimes referred to herein as Compound A), an alternative quaternary ammonium compound (A1) (sometimes referred to herein as Compound A1), a quaternary ammonium compound (B) (sometimes referred to herein as Compound B), and a super spreading agent (C). The quaternary ammonium compound (A) or (A1), the quaternary ammonium compound (B), and the super spreading agent (C) are preferably present in the composition in a ratio relative to each other of 10 parts quaternary ammonium compound (A or A1) to 10 parts quaternary ammonium compound (B) to 1 part super spreading agent (C), less preferably as shown in the following formulation.

Preferably, quaternary ammonium compound (A or A1), quaternary ammonium compound (B), and super spreading agent (C) are present in the pharmaceutical composition in a ratio relative to each other of 10 parts quaternary ammonium compound (A or A1) to 10 parts quaternary ammonium compound (B), to 1 part super spreading agent (C), less preferably 4-6 parts quaternary ammonium compound (A or A1) to 3 to 7 parts quaternary ammonium compound (B), to 0.23-0.43 parts super spreading agent (C), still less preferably 3 to 8 parts quaternary ammonium compound (A or A1) to 0.5 to 2.5 parts quaternary ammonium compound 1 (B), to 0.03-0.46 parts super spreading agent (C).

The table below sets forth a preferred formulation and less preferred formulations of the composition. All figures listed in the following table are in weight percent.

The quaternary ammonium compound (A) is preferably a polymerized quaternary ammonium halide compound, more preferably an alkyl-dimethyl-benzyl-ammonium chloride. Still more preferably, the quaternary ammonium compound (A) is n-alkyl(95% C₁₄, 3% C₁₂, 2% C₁₆)-dimethyl-benzyl-ammonium chloride, CAS #68424-85-1, EPA PC #069184, California DPR #3855X.

The alternative quaternary ammonium compound (A1) is preferably a polymerized quaternary ammonium halide compound, more preferably an alkyl-dimethyl-benzyl-ammonium chloride. Still more preferably, the alternative quaternary ammonium compound (A1) is n-alkyl (100% C₁₂)-dimethyl-benzyl-ammonium chloride, CAS #139-07-1, EPA PC #069124, California DPR #1167.

| | Preferred | Less Preferred | Less Preferred | Less Preferred | Less Preferred | Less Preferred |
|---|---|---|---|---|---|---|
| Compound A | 10 | 4-6 | 3-8 | 2-25 | 1-50 | .001-95 |
| Compound B | 10 | 3-7 | 1-10 | .05-2.5 | .05-50 | .001-95 |
| Compound C | 1 | .23-.43 | .1-.45 | .03-.46 | .01-5 | .00002-1.9 |

The quaternary ammonium compound (B) is preferably a polymerized quaternary ammonium halide compound, more preferably an alkyl-dimethyl-ethylbenzyl-ammonium chloride. Still more preferably, the quaternary ammonium compound (B) is n-alkyl (68% C₁₂, 32% C₁₄)-dimethyl-ethylbenzyl-ammonium chloride, CAS #85409-23-0, EPA PC #069154, California DPR #1854.

The super spreading agent (C) is preferably selected from the group consisting of the organosilicone wetting agents, the fluoro-organic wetting agents, or more preferably selected from the group of low volatile organic content acetylenic diols, and mixtures thereof. Still more preferably, the super spreading agent (C) is either a low molecular weight nonionic silicon polyether surfactant (e.g. Dow Corning Q2-5211) or an acetylenic diol, nonionic, ultra-low VOC, low foaming, super wetting agent (e.g. Air Products DYNOL 64).

The extracted quaternary ammonium polymers of this invention represent fusing and lysing vectors for pathogen membrane destruction. The quaternary ammonium cations are the fusing agents that migrate to and bind onto the negatively charged cell membrane, essentially delivering the halide ion destructive payload that lyses the pathogen membrane via phospholipid bilayer disruption. The super spreading agent C is needed to help deliver the carrier-payload past hydrophobic-lipophilic substrate surface tensions, and through the pathogen cell capsule and porous cell wall to the targeted membrane.

Depending upon the substrate involved, the positively charged un-polymerized quaternary ammonium compound would otherwise tend to be heavily absorbed or bound by the negatively charged substrate surface, eliminating its cationic vector and ability to deliver its lysing payload to the pathogen. The super spreading agent facilitates its homogeneous availability throughout the substrate.

Anionic surfactants, such as soap, and polymeric/non-polymeric quaternary ammonium form ion-pairs, or precipitate in aqueous solutions and cannot be used. Electrostatic interaction between the surfactant ion and the quaternary ammonium cation neutralize the net charge and the electrostatic migration activity, together with loss of hydrophilicity, resulting in precipitation. Yu in U.S. Pat. No. 7,157,412, entitled “Alkylamine as an antimicrobial agent in ophthalmic compositions”, teaches the presence of a non-ionic surfactant at a cleaning agent level would usually cause a significant, if not complete, loss of antimicrobial activity for non-polymeric quaternary ammonium or alkylamine. Non-ionic surfactant is commonly used in microbiology tests to stop quaternary ammonium/alkylamine activity during tests.

We have discovered that the afore-mentioned polymer/monomer quaternary ammonium compounds can be made soluble in aqueous solutions using certain types of non-ionic, super spreading surfactants, used in a special mixing ratio in amounts that avoid neutralizing the antimicrobial activity. Preferred non-ionic surfactants include those that contain an alkyl chain. The maximum ratios of antimicrobial polymer to super spreading surfactant before neutralization depends upon the hydrophobicity/hydropholicity of the surfactant and the amount of antimicrobial. The maximum ratios of A+B to C in this invention are between 100:1 and 20:1.

Definition of Terms In addition to terms defined herein elsewhere, the following terms have the following definitions herein:

The article “a” or “an” includes not only the singular, but also the plural of the object to which the article relates.

“Bulk resin” means a resin in any form, such as pellets, beads, flakes or powder or the like, prior to forming into a product. Often additives are blended with the bulk resin prior to forming to impart such properties as: antimicrobial, antioxidation, UV resistance, color, fire retardance, etc.

“Coupling agent” A coupling agent is a molecule used to form a bridging chemical bond between two different materials, such as between a metal oxide powder and an antimicrobial polymer. In general, coupling agents will posses dual chemical functionality. In other words, it will be capable of reacting by two different chemical mechanisms to link dissimilar materials. 3-(trimethoxysilyl)propyl methacrylate is an organosilane coupling agent used to join quaternary ammonium polymers to the surface of mica powder. An “organosilane” is a compound or molecule containing silicon atoms, wherein silicon atoms are covalently-bonded to one or more carbon atoms.

“Formed plastic product” means a polymeric resin that has been formed into a shape using various molding, extrusion, pultrusion or other forming techniques.

“Free Radical” means a chemical species that possesses an unpaired covalent electron, characterized by a high chemical reactivity.

“Hydrolyzable” “Non-hydrolyzable” is meant a bond that does not hydrolyze under standard conditions to which a bond is expected to be exposed under normal usage of the material or surface having such bond. For instance, in a powder having an antimicrobial polymer bonded to its surface by “non-hydrolyzable” bonds according to the present invention, such “non-hydrolyzable” bonds do not hydrolyze (e.g., undergo a hydrolysis-type reaction that results in the fission of such bond) under normal storage conditions of such dressing, or exposure to wound exudates and/or body fluids when in use (e.g., under exposure to an expected range of pH, osmolality, exposure to microbes and their enzymes, and so forth, and added antiseptic salves, creams, ointments, etc.). The ranges of such standard conditions are known to those of ordinary skill in the art, and/or can be determined by routine testing.

“Leaching” Non-leaching means that sections of the polymer of the present invention do not appreciably separate from the material and leave the substrate to which it is bound or otherwise become non-integral with the material under standard uses. It is noted that “non-leachable” refers to the bond between the polymer chain and the powder substrate. the typical bond between the polymer chain and antimicrobial groups envisioned and enabled herein are covalent bonds that do not leach under standard exposure conditions. By “not appreciably separate” is meant that no more than an insubstantial amount of material separates, for example less than one percent, preferably less than 0.1 percent, more preferably less than 0.01 percent, and even more preferably less than 0.001 percent of the total quantity of polymer. Alternately, depending on the application, “not appreciably separate” may mean that no adverse effect on wound healing or the health of an adjacent tissue of interest is measurable.

“Polymer” means a large molecule made by covalently binding many smaller molecules. It is built up by the repetition of small chemical units (monomers). The resulting chains can be linear, cyclic, branched or cross-linked into three-dimensional networks. By “degree of polymerization” is meant the number of monomers that are joined in a single polymer chain. For example, in a preferred embodiment of the invention, the average degree of polymerization is in the range of about 5 to 1,000. In another embodiment, the preferred average degree of polymerization is in the range of about 10 to 500, and in yet another embodiment, the preferred average degree of polymerization is in the range of about 10 to 100.

The term “quaternary ammonium” or “quaternary amine” are used interchangeably. Both are common chemical nomenclature and their meaning will be understood by one skilled in the art.

“Resin” means a synthetic polymeric plastic that may be thermoplastic or thermosetting.

“Substrate” means a product to which the antimicrobial quaternary ammonium polymer composition is applied or with which it is mixed or otherwise blended or reacted to impart the substrate with sustained antimicrobial properties.

“Thermoplastic” polymer or resin means a polymer where no chemical bonds form with other chains. The polymer will melt with the addition of heat.

“Thermoset” polymer or resin means a polymer where chemical bonds form between chains resulting in a 3-dimensional cross-linked structure. These polymers do not melt.

As mentioned above, one aspect of the present invention relates to a composition containing one or more antimicrobial polymers containing quaternary ammonium groups, the polymers comprising repeating units in their structures with independent non-hydrolysable organic groups; and an alkyl group of preferably 12 to about 14 carbon atoms (to maximize anti-microbial properties); with chloride as the anionic moiety suitable to form the salt of the repeating units.

One method of the present invention uses the technology of polymerizing a quaternary ammonium salt monomer to create a polymer with two or more quaternary ammonium salt repeating units to form a homopolymer in solution or as a solid. The resulting polymer has superior antimicrobial properties compared to the source monomer.

Other methods also use the technology of linking the quaternary ammonium salt monomer to an existing polymer with reactive side groups to form an antimicrobial polymer with pendant quaternary ammonium salt groups.

One method of preparing the preferred quaternary ammonium polymer includes adding with agitation the monomer to an excess of solvent, such as water, along with heat and/or a catalyst such as a mineral or organic acid or base, which initiates a condensation polymerization process. The polymer is recovered from resulting precipitation or solvent removal.

More specifically, one embodiment of the method of making the polymer having repeating units comprises: (a) providing a monomeric quaternary ammonium salt capable of forming the polymer having the repeating units, (b) hydrolysing the monomer with water to form OH groups; and (c) condensing the OH groups to form the polymer.

Even more specifically, an embodiment of the method further comprises a preliminary step before step (a) that comprises dissolving the monomeric quaternary ammonium salt in a solvent to form a solution; the hydrolysis steps (b) further comprises mixing the solution and water preferably in the presence of heat and/or a catalyst; the condensation step (c) preferably further comprises subjecting the solution undergoing hydrolysis to heat and/or removal of water or the other solvent to drive the reaction further to completion to form the polymer; and the method further comprises a step (d) of recovering the polymer by one of precipitation and solvent removal. A preferred further step is step (e) of drying the recovered polymer, preferably by heating to evaporate the solvent, resulting in the polymer being solvent-free, where solvent-free means that the polymer may contain residual solvent up to about 10 weight percent of the polymer.

The solvent is any suitable solvent, such as, without limitation, water, an alcohol, such as ethanol, propanol, isopropanol or butanol, a ketone, such as methyl ethyl ketone, an aldehyde, such as butyl aldehyde, an aliphatic hydrocarbon, such as pentane or hexane, an aromatic hydrocarbon, such as toluene or xylene, a glycol ether, such as diethylene glycol monomethyl ether or ethylene glycol dibutyl ether, and a halogenated hydrocarbon, such as 1,1,1-trichloroethane or tetrachloroethane. Exemplary preferred solvents include, without limitation, water, alcohols such as isopropyl alcohol and t-butyl alcohol, tetrahydrofuran, chloroform, carbon tetrachloride, ethylene glycol, propylene glycol and ethyl acetate. If water is the only solvent, there is a molar excess to hydrolyse the OR groups to OH. If the reaction is conducted in another solvent, a stoichiometric amount of water is then added to hydrolyse the OR groups.

Preferably, the catalyst is a mineral acid, an organic acid or a base. Preferably, the acid is hydrochloric acid, sulfuric acid or acetic acid. Preferably, the base is sodium hydroxide, potassium hydroxide, ammonium hydroxide, an aliphatic amine, such as dimethylamine, tetramethylenediamine or hexamethylenediamine, a cycloaliphatic amine such as morpholine or cyclohexylamine, or an aryl amine such as aniline or diphenylamine.

Another embodiment of a method of making a polymer according to the present invention is where the polymer is a copolymer of a monomer and a host polymer having repeating units.

The antimicrobial quaternary ammonium salt solution includes as a solvent for the antimicrobial agent any solvent that may effectuate the conversion of the hydrolysable groups, such as the methoxy groups, on the quaternary ammonium salt to OH groups. Preferably, for the antimicrobial quaternary ammonium salt solution, the solvent is selected based on its ability to dissolve the antimicrobial quaternary ammonium salt. The concentration of the solution may be about 1% to about 99% by weight of the antimicrobial quaternary ammonium salt. Preferably, about 1% to about 75% by weight of the antimicrobial quaternary ammonium salt is used, and more preferably about 1% to about 50% by weight is used.

After the quaternary ammonium salt monomer has been combined with the solvent, the quaternary ammonium salt is polymerized to form the antimicrobial homopolymer. Such polymerization preferably is achieved by mixing the solution of the quaternary ammonium salt monomer used to form the polymeric antimicrobial agent with a catalyst, which may be a base, such as those mentioned above, an acid, such as those mentioned above, or heat, or a combination of a base or acid and heat. The base and acid may have concentrations of about 0.0N to about 1N. An effective temperature for polymerization is about 10 degrees C. to about 300 degrees C., preferably about 30 degrees C. to about 100 degrees C., and more preferably about 20 degrees C. to about 50 degrees C. In general, the greater the temperature, the less time it takes for the antimicrobial polymer to form.

Another embodiment of the present invention is a method of making an addition polymer by chain-growth polymerization using Free Radical initiators. Solution ionic polymerization initiated and propagated by anions or cations is not preferable for this invention given the inherently cationic state of all quaternary ammonium compound monomers.

The free radical addition polymerization may be carried out by bulk polymerization using only the quaternary ammonium salt monomer and a free radical initiator. Bulk polymerization creates a very pure polymer and yields the greatest amount of polymer per reactor volume.

A free radical solution polymerization may be carried out using an inert solvent, such as water, or the solvents described in the condensation polymerization methods above, added with the monomer and initiator which increases heat capacity and reduces mass viscosity, facilitating convective heat transfer in the reaction mass.

Suspension free radical polymerization of the quaternary ammonium salt monomer may be carried out by dispersing the organic reaction mass as droplets in a continuous aqueous phase, whereby the polymerization reactions occur in each tiny drop. This approach further lowers viscosity and increases the heat capacity/removal through a reactor cooling jacket.

Finally, an emulsion free radical polymerization can be carried out using commercially available compatible emulsification chemicals in an aqueous continuous phase.

The free radical initiators of this method may be organic peroxides, inorganic peroxides, azo compounds, or carbon-carbon initiators. The preferred free radical initiators for this method are organic peroxides for free radical solvent polymerization and inorganic peroxides for emulsion free radical polymerization.

There are one hundred different organic peroxides, including the preferred diacyl peroxides and dialkyl peroxydicarbonates. Inorganic peroxides of this method include hydrogen peroxide-ferrous sulfate, hydrogen peroxide-dodecyl mercaptan, potassium peroxydisulfate-sodium bisulfate, and potassium peroxydisulfate-dodecylmercaptan.

The methods of making either the antimicrobial condensation or addition polymers described above create a polymeric antimicrobial quaternary ammonium salt, which can be incorporated into resins and materials to create substrates with sustained antimicrobial properties. The solid antimicrobial polymer can be used to treat materials by different methods of incorporating the antimicrobial polymer into the materials. Such procedures may include, for example, without limitation: A. Dry blending the antimicrobial polymer with a bulk resin (such as in powder, flake, pellets, bead form) prior to molding; B. Dissolving the antimicrobial polymer and bulk resin in a common solvent, then removing the solvent prior to molding; C. Using methods A or B to make a concentrate with a portion of the bulk resin prior to blending with the remainder of the bulk resin; D. Adding the antimicrobial polymer into coating and paint formulations; E. Dissolving the antimicrobial polymer in a solvent to enable treatment of various materials by dipping, spraying, brushing; F. The antimicrobial polymer can be copolymerized with other polymers as a method of incorporation into such other polymers or a bulk resin containing them.

Types of applications for the antimicrobial polymer include as examples, but not limited to, a paint thin film for use with latex or other paints for painting any surface; a laminate; a medical product; coating air purification filter media and the HVAC ducting; building material, such as a counter top, roofing products like shingles, floor or ceiling tile or wall covering, doorknob, toilet handle; packaging material; paper products, toys, grocery cart handles, furniture or any other product where antimicrobial properties are desired. Other products include various types of materials or substrates, such as thermoset polymeric resin, composition wood which may include synthetic polymeric components, such as oriented strand board; plywood; paper products, textiles, activated carbon, etc.

By way of example without limitation, types of resins that can be treated with the antimicrobial polymer are: polyvinyl chloride, polyurethane, urea formaldehyde, melamine formaldehyde, polyvinyl pyrrolidone, polyvinyl alcohol, polyacrylic, polystyrene acrylic, polyvinyl acrylic, or any other suitable resin. The resin may be a thermoplastic resin or a thermoset resin.

In the embodiment of the method of the invention using the solid form of the polymerized antimicrobial quaternary ammonium salt, either as a polymerized coating on the host polymeric resin particles, or as discrete solid particles of the polymeric quaternary ammonium salt, the solid form of the antimicrobial agent may be melt blended or the like with separate resin beads, etc., to form the desired antimicrobial bulk polymeric resin. Such blending, which may be mixing, extrusion, pultrusion or the like, involves the use of a well known industrial mixer or extruder, such as but not limited to a Welex® mixer or Welex® extruder. The solid antimicrobial agent and the resin particles are added to the mixer in the desired proportions as set forth below and mixed at an elevated temperature where the components melt but do not degrade. The temperature should be sufficient to allow the formerly solid components to flow and uniformly blend with each other. The time to accomplish uniform blending such that a uniform mixture results varies based on the temperature and equipment used, but in general, should be sufficient to provide a uniform blend of the polymeric antimicrobial agent and the polymeric resin, whereby the resulting product will have sustained antimicrobial properties. A suitable temperature is preferably about 60 degrees C. to about 350 degrees C., more preferably about 100 degrees C. to about 325 degrees C., and even more preferably, about 150 degrees C. to about 300 degrees C. The mixing process results in the polymeric resin beads being evenly coated with or distributed uniformly and blended with the polymeric antimicrobial agent to form the antimicrobial bulk polymeric resin. The resulting polymeric resin has sustained antimicrobial properties that will continue to be sustained when the polymeric resin is formed into a substrate of any desired configuration, such as thin sheets for example, or any formed plastic product made from the substrate or directly from the polymeric resin.

The polymerized quaternary ammonium salt is “anchored” to the resin and substrate through physical blending, van der Waals forces, and chemical covalent bonding, depending on the nature of the polymeric resin substrate. The presence of the active polymeric quaternary ammonium group with the polymeric resin substrate is substantiated by a dye test using Bromophenol blue. The longevity or permanence of the quaternary ammonium group can be demonstrated by dye testing the treated material after repeatedly challenging the treated host substrate with multiple hot (e.g., 140 degrees F., 60 degrees C.) water rinses, aging treated samples with forced air or in a microwave oven, and subjecting the treated sample to repeated boiling water for 30 minutes.

The concentration of the quaternary ammonium salt polymer should be less than about 50% by weight of the final bulk polymeric resin matrix to minimize adversely affecting properties of the host polymeric resin. The amount of antimicrobial agent to the host resin preferably is about 0.025% to about 50%, more preferably about 0.05% to about 20%, and even more preferably, about 0.15% to about 0.5%, where the percentages are weight percentages.

The resin substrate may be formed from a resin concentrate where a resin with a high concentration of the antimicrobial quaternary ammonium salt polymer is blended with the resin without any of the antimicrobial quaternary ammonium salt polymer in concentrations such that the final blend contains the desired amount of antimicrobial quaternary ammonium salt polymer. Such an antimicrobial bulk resin made from the solid polymer of the antimicrobial quaternary ammonium salt can be formed into a substrate of any desired shape or size using well-known plastic molding and extrusion techniques.

Tubing is manufactured by adding the antimicrobial resin beads in an extrusion mixer, such as a Welex®. extruder at an elevated temperature not to exceed 350 degrees C. Molded parts can be made by adding the antimicrobial resin beads in an injection molder at temperatures not to exceed 350 degrees C.

If a medical device is desired, a block of the antimicrobial polymer is prepared and properly machined to the desired device dimensions.

If a thin layer film or laminate is desired, it may have any desired dimensions, based on the available equipment used to make the product. Typically, but not exclusively, the thin layer has a thickness of about 0.001 inch (0.025 mm) to about 3 inches (76.2 mm), preferably about 0.01 inch (0.25 mm) to about 1 inch (25.4 mm), and more preferably about 0.063 inch (1.6 mm) to about 0.25 inch (6.35 mm). Several layers could be made at the same time and pressed together to form a thicker layer or a laminated substrate. Multiple layers of the same material or different material can be formed into a laminate.

In addition, the present invention includes the additive or preferably synergistic combination of antimicrobial agents comprising one or more polymeric quaternary ammonium salts with at least one other antimicrobial agent. Such other antimicrobial agents may include, by way of example and not limitation, boric acid, polyhexamethylenebiguanide, hydantoin, a silver salt and a combination thereof.

What is claimed is:

1. A polymer based disinfecting composition which exhibits germicidal properties but is non-toxic to humans, comprising a first quaternary ammonium compound, a second quaternary ammonium compound, a process for polymerizing and extracting each of the two quaternary ammonium compound polymers, further compounding the admixture of extracted polymers with a super spreading surfactant, and thereafter integrating the composition into a substrate needing internal or surface pathogen disinfection properties.

2. A composition according to claim 1, wherein said first quaternary ammonium compound may be an alkyl-dimethyl-benzyl-ammonium chloride, and said second quaternary ammonium compound is an alkyl-dimethyl-ethylbenzyl-ammonium chloride.

3. A composition according to claim 1, wherein said first quaternary ammonium compound may preferably be n-alkyl (95% C₁₄, 3% C₁₂, 2% C₁₆)-dimethyl-benzyl-ammonium chloride.

4. A composition according to claim 1, wherein in the alternative, said first quaternary ammonium compound may be n-alkyl (100% C₁₂)-dimethyl-benzyl-ammonium chloride.

5. A composition according to claim 1, wherein said second quaternary ammonium compound is n-alkyl (68% C₁₂, 32% C₁₄)-dimethyl-ethylbenzyl-ammonium chloride.

6. A composition according to claim 1, said composition being about 1.0 to 50.0 weight percent said first polymerized quaternary ammonium compound, and about 0.05 to 50.0 weight percent said second polymerized quaternary ammonium compound.

7. A composition according to claim 6, wherein the weight ratio of said first quaternary ammonium compound to said second quaternary ammonium compound is from 10:0 to 0:10.

8. A method of making the polymers of claim 1, the method comprising: (a) providing said first and second monomeric quaternary ammonium compounds, each capable of forming a polymer having repeating units; (b) hydrolyzing the monomers of (a) with a solvent to form OH groups; and (c) condensing the OH groups to form the polymers of claim 1.

9. The method of claim 8, wherein the monomeric quaternary ammonium compounds capable of forming the polymers having repeating units are monomers of the quaternary ammonium compounds of claims 3, 4, and 5.

10. The method of claim 8, further comprising a preliminary step before step (a) comprising dissolving the monomeric quaternary ammonium compounds in a solvent to form a solution; the hydrolysis and condensation steps (b) and (c) further comprise mixing the solution and water in the presence of a catalyst to form the polymer; the method further comprising (d) recovering the polymer by precipitation, solvent removal, and drying.

11. The method of claim 10, wherein the solvent is selected from the group consisting of water, an alcohol, a ketone, an aldehyde, an aliphatic hydrocarbon, an aromatic hydrocarbon, a glycol ether and a halogenated hydrocarbon.

12. The method of claim 10, wherein the catalyst is selected from the group consisting of a mineral acid, an organic acid and a base.

13. The method of claim 10, wherein the acid is selected from the group consisting of hydrochloric acid, sulfuric acid and acetic acid.

14. The method of claim 10, wherein the base is selected from the group consisting of sodium hydroxide, potassium hydroxide, ammonium hydroxide, an aliphatic amine, a cycloaliphatic amine and an aryl amine.

15. An alternative method of making the polymers of claim 1, the method comprising (a) providing said first and second monomeric quaternary ammonium compounds, each capable of forming a polymer having repeating units; and (b) carrying out a free radical addition polymerization of the monomers, with or without a solvent, dispersing agent, or emulsifier.

16. The method of claim 15 wherein the monomeric quaternary ammonium compounds capable of forming the polymers having repeating units are monomers of the quaternary ammonium compounds of claims 3, 4, and 5.

17. The method of claim 15 further comprising recovering the polymer by precipitation, solvent removal, and drying.

18. The method of claim 15 wherein (a) the solvent is selected from the group consisting of water, an alcohol, a ketone, an aldehyde, an aliphatic hydrocarbon, an aromatic hydrocarbon, a glycol ether and a halogenated hydrocarbon; and (b) the free radical initiator is selected from the group consisting of organic peroxides, inorganic peroxides, azo compounds, and carbon-carbon initiators.

19. The methods of claims 10 and 15, wherein the composition of extracted polymers is compounded with about 0.01 to 5.0 weight percent of a super spreading agent selected from the group consisting of the organosilicone wetting agents, the fluoro-organic wetting agents, the low volatile organic content acetylenic diols, and mixtures thereof.

20. A method of making a substrate with sustained antimicrobial properties, the method comprising: (a) providing the substrate; (b) providing the compound according to claim 19; (c) forming a substrate with sustained antimicrobial properties by one of (i) dry blending the substrate and the compound of claim 19, (ii) forming a solution of the compound of claim 19 and mixing the solution with the substrate, and (iii) coating or embedding the substrate with the compound of claim 19.
